(19) United States
(12) Patent Application Publication
(10) Pub. No.: US 2026/0044125 A1
(43) Pub. Date: Feb. 12, 2026

(54) USER-ASSISTED OBJECT IDENTIFICATION FOR TRAINING A MACHINE LEARNING MODEL

(71) Applicant: Caterpillar Inc., Peoria, IL (US)

(72) Inventor: Craig Allan LEHOCKY, Pittsburgh, PA (US)

(73) Assignee: Caterpillar Inc., Peoria, IL (US)

(21) Appl. No.: 18/798,216

(22) Filed: Aug. 8, 2024

(51) Int. Cl. G05B 13/02; G06N 20/00

(52) U.S. Cl. CPC G05B 13/0265; G06N 20/00

(57) ABSTRACT

A controller may identify, with a machine learning model using sensor data collected by a perception sensor of a work machine, and during an operating time period of the work machine at a worksite, a label for an object in an environment of the work machine. The controller may store sample data, from the sensor data, that relates to the object. The controller may cause, after the operating time period, presentation of review information in a user interface of the work machine, where the review information includes the sample data and a request for user input relating to the label for the object. The controller may receive, via the user interface, the user input. The user input may be for use as training data for the machine learning model.

### TECHNICAL FIELD

The present disclosure relates generally to work machines and, for example, to user-assisted object identification for training a machine learning model.

### BACKGROUND

Machines may be used to perform a variety of tasks at a worksite. For example, machines may be used to excavate, move, shape, contour, and/or remove material present at the worksite, such as gravel, concrete, asphalt, soil, and/or other materials. A machine may include a system for detecting objects at the worksite that may be of interest to the machine operator and/or to an autonomous control of the machine. However, the system may be prone to inaccurately detecting objects, thereby reducing the value of such systems. For example, the system may fail to detect objects, falsely detect objects, and/or misidentify objects, thereby resulting in unnecessary avoidance actions being taken for the machine, excessive machine downtime, work delays, and/or operator dissatisfaction.

The identification system of the present disclosure solves one or more of the problems set forth above and/or other problems in the art.

### SUMMARY

An identification system may include a perception sensor configured to collect sensor data relating to objects in an environment of a work machine, and a controller communicatively coupled to the perception sensor. The controller may be configured to identify, with a machine learning model using the sensor data, and during an operating time period of the work machine at a worksite, a label for an object in the environment of the work machine and a confidence value associated with the label. The controller may be configured to store, based on the confidence value failing to meet a threshold, sample data, from the sensor data, that relates to the object. The controller may be configured to cause, after the operating time period, presentation of review information in a user interface of the work machine, where the review information includes the sample data and a request for user input relating to the label for the object.

A method may include identifying, with a machine learning model using sensor data collected by a perception sensor of a work machine, and during an operating time period of the work machine at a worksite, a label for an object in an environment of the work machine. The method may include storing sample data, from the sensor data, that relates to the object. The method may include causing, after the operating time period, presentation of review information in a user interface of the work machine, where the review information includes the sample data and a request for user input relating to the label for the object. The method may include receiving, via the user interface, the user input, wherein the user input is for use as training data for the machine learning model.

A work machine may include a perception sensor configured to collect sensor data relating to objects in an environment of the work machine, and a controller communicatively coupled to the perception sensor. The controller may be configured to identify, with a machine learning model using the sensor data, and during an operating time period of the work machine at a worksite, a label for a terrain feature in the environment of the work machine. The controller may be configured to store sample data, from the sensor data, that relates to the terrain feature. The controller may be configured to cause, after the operating time period, presentation of review information in a user interface, wherein the review information includes the sample data and a request for user input relating to the label for the object.

### BRIEF DESCRIPTION OF THE DRAWINGS

FIG. 1 is a perspective view of an example machine.

FIG. 2 is a diagram illustrating an example identification system.

FIG. 3 is a diagram illustrating an example of review information presented in a user interface.

FIG. 4 is a flowchart of an example process associated with user-assisted object identification for training a machine learning model.

### DETAILED DESCRIPTION

This disclosure relates to an identification system, which is applicable to any work machine. For example, the work machine may be a compactor machine, a paving machine, a cold planer, a grading machine, a backhoe loader, a wheel loader, a harvester, an excavator, a motor grader, a skid steer loader, a tractor, a dozer, or the like.

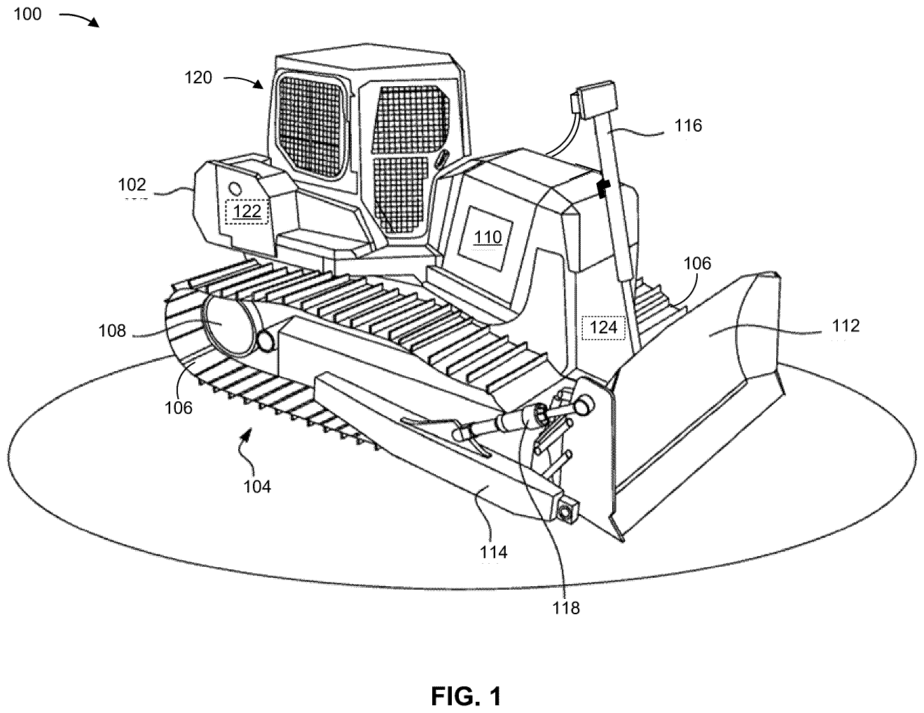

FIG. 1 is a perspective view of an example machine 100. The machine 100 may perform earth moving, excavation, or another operation associated with an industry such as construction or mining, among other examples. That is, the machine 100 is a work machine. For example, as illustrated in FIG. 1, the machine 100 is a dozer. However, the machine 100 may be another type of machine, as described above.

The machine 100 includes a frame 102 that is supported by an undercarriage 104 used to propel the machine 100 in a forward direction and/or a rearward direction. The undercarriage 104 is configured to engage a ground surface, such as a road or another type of terrain. As shown, the undercarriage 104 includes a pair of endless tracks 106 driven by respective drive wheels 108. Although the machine 100 is illustrated as having tracks 106, the undercarriage 104 may additionally, or alternatively, include one or more wheels for propelling the machine 100.

The frame 102 supports a prime mover 110. The prime mover 110 may include an engine (e.g., an internal combustion engine), such as a diesel engine, a gasoline engine, or a gaseous fuel engine, among other examples. Additionally, or alternatively, the prime mover 110 may include an electric motor (e.g., for electric powering of machine 100 or hybrid powering of machine 100 with the engine). The prime mover 110 is configured to provide power to drive the tracks 106. Furthermore, the prime mover 110 is configured to provide power to an implement 112 (e.g., by driving one or more hydraulic pumps that provide pressurized fluid to one or more actuators of the machine 100).

In FIG. 1, the implement 112 (e.g., a work implement) is illustrated as a blade. However, the implement 112 may be, for example, a bucket, a scoop, a moldboard, a compaction drum, a milling drum, a hook, and/or a ripper, among other examples. The implement 112 is movable with respect to the frame 102. For example, the implement 112 may be pivotally connected to the frame 102 by arms 114 on each side of the machine 100. One or more first hydraulic cylinders 116 may be coupled to the frame 102 to support the implement 112 in the vertical direction and allow the implement 112 to move up or down vertically. Additionally, one or more second hydraulic cylinders 118 may be included on each side of the machine 100 to allow a pitch or an angle of the implement 112 to change. In some examples, the first hydraulic cylinders 116 and/or the second hydraulic cylinders 118 may be differently configured or positioned on the machine 100 from that shown in FIG. 1, or may be omitted from the machine 100. The first and second hydraulic cylinders 116, 118 may be actuators that receive actuation instructions to adjust, lift, lower, or otherwise move and/or position the implement 112. In some examples, the implement 112 may be connected to the frame 102 by a boom assembly (e.g., including a boom member and a stick member) configured to be articulated relative to the frame 102 by one or more hydraulic cylinders.

An operator station 120 may be supported on the frame 102. The operator station 120 may include an operator console having one or more displays (e.g., touchscreen displays) and/or one or more operator controls to operate and/or drive the machine 100. For example, the operator controls may include a joystick, a lever, and/or a knob, among other examples. The machine 100 includes a controller 122 for electrically controlling various aspects of the machine 100. For example, the controller 122 may send and receive signals from various components of the machine 100 during the operation of the machine 100.

In some implementations, the controller 122 may be configured to provide autonomous control of the machine 100 or autonomous control of one or more functions of the machine 100 (e.g., propulsion, braking, steering, implement movement, or the like). The machine 100 may include a perception sensor 124 that is communicatively coupled to the controller 122 (e.g., by a wired connection or wirelessly). The perception sensor 124 may be configured to collect sensor data relating to objects in an environment of the machine 100. For example, the perception sensor 124 may include one or more sensors configured to generate two-dimensional data or three-dimensional data (e.g., individually or collectively). As an example, the perception sensor 124 may include one or more cameras, lidar sensors, radar sensors, and/or ultrasound sensors, among other examples. In some examples, the sensor data may include image data collected by one or more cameras.

As indicated above, FIG. 1 is provided as an example. Other examples may differ from what is described with regard to FIG. 1.

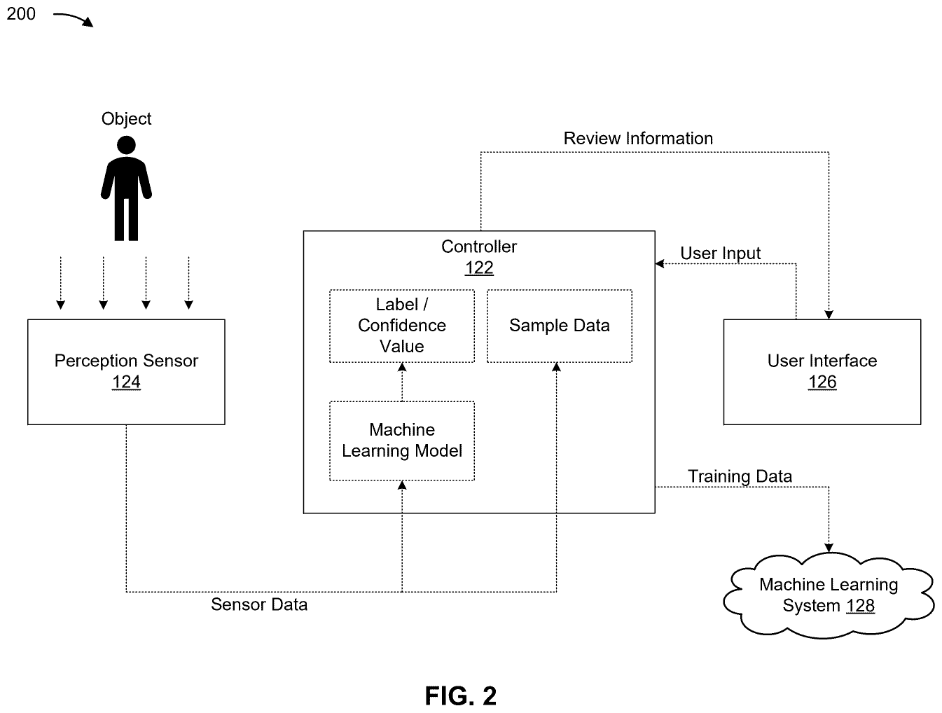

FIG. 2 is a diagram illustrating an example identification system 200. The identification system 200 may include the controller 122, the perception sensor 124, and a user interface 126.

The controller 122 may include one or more memories and one or more processors communicatively coupled to the one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 122.

The controller 122 and the perception sensor 124 may be parts of a perception system of the machine 100. The perception system may be used in connection with autonomous control of the machine 100, or other operator-assistance functions of the machine 100 (e.g., collision warnings, collision avoidance, or the like). For example, the perception system may be or may include a computer vision system, an autonomous driving system, a collision warning system, or the like. The perception system may use artificial intelligence (AI) to detect and identify objects in the environment of the machine 100. For example, the controller 122 may implement a machine learning model that is trained (e.g., by another device off-board the machine 100) to detect and identify objects in the environment of the machine 100 using sensor data collected by the perception sensor 124. In particular, the machine learning model may be trained to identify objects of interest for a worksite, such as humans (e.g., both with or without personal protective equipment), light vehicles (e.g., cars, pickup trucks, vans, or the like), work machines (e.g., dozers, excavators, motor graders, trucks, wheel loaders, compactors, or the like), terrain features (e.g., berms, piles (of dirt, aggregate, or the like), ditches, trenches, rocks, boulders, or the like), culvert sections, fences, fuel stations, generators, guard rails, water hydrants, cinder blocks, Jersey barriers, metal plates (e.g., covering ground areas), portable toilets, shipping containers, trailers, toolboxes, construction barrels, construction cones, wellheads, and/or pipes, among other examples.

The user interface 126 is communicatively coupled to the controller 122 (e.g., by a wired connection or wirelessly). The user interface 126 may include a system of hardware (e.g., input devices and/or output devices) and/or software through which a user (e.g., an operator of the machine 100, a supervisor of the worksite, or the like) can interact with the controller 122. The user interface 126 may include a touchscreen display, a human-machine interface (HMI), a computer system, a virtual reality headset, an augmented reality headset, or the like. The user interface 126 may be on-board the machine 100 (e.g., in the operator station 120), may be off-board the machine 100 (e.g., at a back office location), or may be portable (e.g., a remote control device, a tablet computer, or the like).

During an operating time period of the machine 100, the controller 122 may process sensor data collected by the perception sensor 124. The operating time period may begin at a start-up event of the machine 100 (e.g., a key-on event), and may conclude at a shut-down event of the machine 100 (e.g., a key-off event). In some examples, the operating time period may correspond to a duration of a work shift associated with an operator of the machine 100, or to another pre-set time period (e.g., a day, a week, a month, or the like).

During the operating time period, the controller 122 may identify, with the machine learning model using the sensor data, a label for an object in the environment of the machine 100 (e.g., an object of interest that the machine learning model is trained to identify) and a confidence value associated with the label. For example, the sensor data may capture (e.g., depict) the object (e.g., in an image, in a three-dimensional point cloud, or the like), and the controller 122, using the machine learning model, may identify the label for the object and the confidence value based on the sensor data. The label may represent an identification or a classification that the controller 122 has determined for the object. For example, the label may indicate that the object has been identified as a human, a boulder, or a construction barrel. The confidence value may indicate a level of confidence (e.g., from 0% to 100%) that the label correctly identifies the object. In some cases, the sensor data may capture multiple objects that are concurrently present in the environment of the machine 100. Accordingly, the controller 122 may identify, with the machine learning model using the sensor data, respective labels for each of the objects and respective confidence values associated with the labels. In some implementations, the controller 122 may cause the label for the object to be presented in the user interface 126 (e.g., in real time once the label is identified). For example, the controller 122 may cause the label to be presented as an overlay (e.g., an augmented reality overlay) on real-time video of the environment of the machine 100.

As the controller 122 identifies labels for objects captured in the sensor data, the controller 122 may determine whether a confidence value associated with a label fails to meet a threshold (e.g., whether the confidence value is lower than or equal to the threshold, or the confidence value is higher than or equal to the threshold, depending on the configuration of the scale used for confidence values). The confidence value failing to meet the threshold may indicate a low confidence level for the label correctly identifying the object. Based on the confidence value failing to meet the threshold, the controller 122 may store (e.g., in a memory of the controller 122) sample data, taken from the sensor data, that relates to the object. For example, the sensor data may include a series of images, and the sample data may be an image frame, from the series of images, that depicts the object. In some implementations, the controller 122 may store the sample data responsive to the label indicating a terrain feature, such as a pile (e.g., even with high confidence in the label, the sample data may be stored to enable subsequent review or inputting of an edge region of the terrain feature, as described herein). In some implementations, the sample data may be stored in association with metadata indicating the label identified for the object and/or a location in the sample data (e.g., coordinates of a bounding box, a segmentation mask, an edge region, or the like) that represents the object.

The controller 122 may perform this process of identifying labels and storing sample data throughout the operating time period. For example, after identifying the label for the object and the associated confidence level, and storing the sample data, the controller 122 may identify, with the machine learning model using the sensor data, an additional label for an additional object in the environment of the machine 100 and an additional confidence value associated with the additional label. Continuing with the example, the controller 122 may store, based on the additional confidence value failing to meet the threshold, additional sample data, taken from the sensor data, that relates to the additional object. Accumulating the sample data in this manner enables assessment of the labels after the operating time period, thereby reducing interruption to operation of the machine 100 and reducing downtime of the machine 100.

After the operating time period, the controller 122 may cause presentation of review information in the user interface 126. For example, the operating time period may conclude at a shut-down event for the machine 100, and the controller 122 may cause presentation of the review information at a start-up event for the machine 100 occurring after the shut-down event (e.g., the next start-up event following the shut-down event or a subsequent start-up event). As another example, the operating time period may conclude at the end of a work shift of an operator of the machine 100, or at another pre-set time period, and the controller 122 may cause presentation of the review information after the end of the work shift or the pre-set time period (e.g., before a shut-down event for the machine 100 or at a start-up event following the shut-down event).

The review information may include the sample data and a request for user input relating to the label for the object. When multiple items of sample data have been stored (e.g., the sample data and the additional sample data, described herein), the presentation of the review information may include sequentially presenting the multiple items of sample data and corresponding requests for user input. The request for user input may request user-assistance relating to whether the identified label correctly identifies the object.

In connection with causing presentation of the review information in the user interface 126, the controller 122 may retrieve the sample data and associated metadata from storage, and may generate the review information based on the sample data and associated metadata. The controller 122 may cause presentation of the review information in the user interface 126 by generating and outputting the review information to the user interface 126, by transmitting the review information to another device to cause the other device to output the review information to the user interface 126, by transmitting the sample data and associated metadata to another device to cause the other device to generate and output the review information to the user interface 126, or by storing the sample data and associated metadata to cause another device to retrieve the sample data and associated metadata from storage and to generate and output the review information to the user interface 126.

In some examples, the request for user input may request that the user input indicate whether the sample data depicts the object in accordance with the label. For example, if the object is labeled as a human, the request may indicate: “Is there a human in this image?” This type of request may be made responsive to the confidence value falling within a lowest-level confidence tier (e.g., the confidence value fails to meet a first, lowest-confidence threshold). The controller 122 may receive, via the user interface 126, the user input in response to the request, which may be a selection (e.g., “yes” or “no”) indicating whether the sample data depicts the object in accordance with the label.

In some examples, the review information may also include an indicia (e.g., a bounding box, a segmentation mask, or the like) that distinguishes a region of the sample data, and the request for user input may request that the user input indicate whether the region includes the object in accordance with the label. For example, if the object is labeled as a human, the request may indicate: “Is there a human within the bounding box?” This type of request may be made responsive to the confidence value falling within a mid-level confidence tier (e.g., the confidence value meets the first, lowest-confidence threshold but fails to meet a second, mid-confidence threshold). The controller 122 (or another device associated with the user interface 126) may receive, via the user interface 126, the user input in response to the request, which may be a selection (e.g., “yes” or “no”) indicating whether the region includes the object in accordance with the label.

In some examples, the request for user input may request that the user input indicate a location in the sample data that depicts the object in accordance with the label. For example, if the object is labeled as a human, the request may indicate: “Tap on the human in the image.” This type of request may be made responsive to the confidence value falling within a high-level confidence tier (e.g., the confidence value meets the first, lowest-confidence threshold and the second, mid-confidence threshold but fails to meet a third, high-confidence threshold, which may correspond to the threshold used for storing sample data, as described herein). The controller 122 (or another device associated with the user interface 126) may receive, via the user interface 126, the user input in response to the request, which may indicate a location (e.g., pixel coordinates) in the sample data associated with the object.

In some examples, the request for user input may request that the user input indicate an edge region (e.g., an entire edge or a portion of an edge) of the object in accordance with the label (e.g., as a modification to a detected edge region, or as a new indication of the edge region). For example, if the object is labeled as a pile, the request may indicate: “Tap around an outline of the pile.” This type of request may be made responsive to the identified label belonging to a particular category (e.g., a terrain feature category or a pile category). For example, if the label belongs to the category, then the request for the user input to indicate the edge region may be made; otherwise, if the label belongs to a different category, then a different type of request, as described herein, may be made. The controller 122 (or another device associated with the user interface 126) may receive, via the user interface 126, the user input in response to the request, which may indicate a set of locations (e.g., a set of pixel coordinates) in the sample data that represent an edge region of the object (e.g., the terrain feature).

Accordingly, the particular request that is made may be based on the confidence value (e.g., where a first request is made if the confidence value is a first value or in a first range, and a second, different request is made if the confidence value is a second value or in a second range) and/or based on the label (e.g., where a first request is made if the label is a first label or belongs in a first category, and a second, different request is made if the label is a second label or belongs in a second category). In some implementations, presentation of the review information may include sequentially presenting the same sample data with a series of different requests (e.g., where each subsequent request is based on the user input responding to a previous request). For example, a first request may request first user input to indicate whether the sample data depicts the object in accordance with the label. If the first user input indicates that the sample data does depict the object in accordance with the label, then a second request may request second user input to indicate whether a region (e.g., surrounded by a bounding box) includes the object in accordance with the label. If the second user input indicates that the region does not include the object in accordance with the label, then a third request may request third user input to indicate a location in the sample data that depicts the object in accordance with the label.

In some implementations, the presentation of the review information, and the responsive user input, may be gamified. For example, the controller 122 may prevent start-up, prevent propulsion, disable features, or the like, of the machine 100 until a user has provided user input for a threshold quantity of items of sample data.

The user input provided via the user interface 126 may be used as training data for the machine learning model. For example, the controller 122 may transmit the sample data, the associated metadata, and/or information based on the user input to a machine learning system 128 to facilitate further training of the machine learning model using the sample data, the associated metadata, and/or the information based on the user input.

As indicated above, FIG. 2 is provided as an example. Other examples may differ from what is described with regard to FIG. 2.

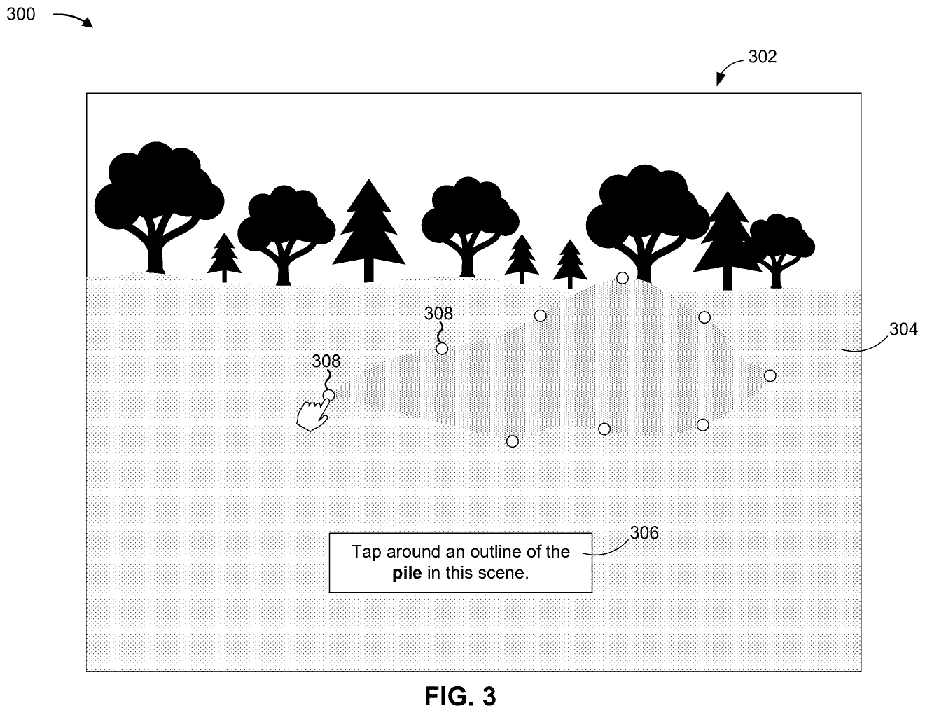

FIG. 3 is a diagram illustrating an example 300 of review information 302 presented in the user interface 126. As described herein, the review information may include sample data 304 and a request 306 for user input. As shown, the sample data 304 may be an image (e.g., an image frame) collected by the perception sensor 124 (e.g., a camera) during an operating time period of the machine 100. In response to the request 306, a user of the user interface 126 (e.g., an operator of the machine 100) may provide the user input 308 via the user interface 126. As shown, the user input 308 may indicate a set of locations in the sample data 304 that represent an edge region of an object depicted in the sample data 304.

As indicated above, FIG. 3 is provided as an example. Other examples may differ from what is described with regard to FIG. 3.

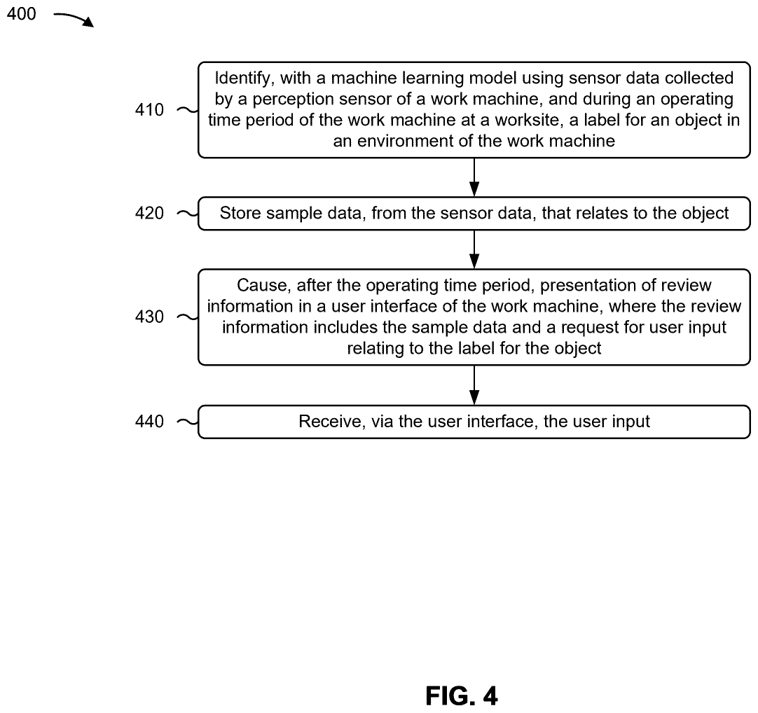

FIG. 4 is a flowchart of an example process 400 associated with user-assisted object identification for training a machine learning model. One or more process blocks of FIG. 4 may be performed by the controller 122. Additionally, or alternatively, one or more process blocks of FIG. 4 may be performed by another device or a group of devices separate from or including the controller, such as another device or component that is internal or external to the machine 100.

As shown in FIG. 4, process 400 may include identifying, with a machine learning model using sensor data collected by a perception sensor of a work machine, and during an operating time period of the work machine at a worksite, a label for an object in an environment of the work machine (block 410). For example, the controller 122 (e.g., using a memory and/or a processor) may identify, with a machine learning model using sensor data collected by a perception sensor of a work machine, and during an operating time period of the work machine at a worksite, a label for an object in an environment of the work machine, as described above. Identifying the label for the object may include identifying the label for the object and a confidence value associated with the label, where sample data may be stored based on the confidence value failing to meet a threshold.

As further shown in FIG. 4, process 400 may include storing sample data, from the sensor data, that relates to the object (block 420). For example, the controller 122 (e.g., using a memory and/or a processor) may store sample data, from the sensor data, that relates to the object, as described above. As an example, the sample data may be stored in association with metadata indicating the label and indicating a location in the sample data that represents the object.

As further shown in FIG. 4, process 400 may include causing, after the operating time period, presentation of review information in a user interface of the work machine, where the review information includes the sample data and a request for user input relating to the label for the object (block 430). For example, the controller 122 (e.g., using a memory, a processor, an output component, and/or a communication component) may cause, after the operating time period, presentation of review information in a user interface of the work machine, as described above. In some examples, the operating time period concludes at a shut-down event for the work machine, and presentation of the review information in the user interface may be caused at a start-up event for the work machine after the shut-down event.

The request for the user input may request that the user input indicate whether the sample data depicts the object in accordance with the label. Alternatively, the review information may further include an indicia that distinguishes a region of the sample data, and the request for the user input may request that the user input indicate whether the region includes the object in accordance with the label. Alternatively, the request for the user input may request that the user input indicate a location in the sample data that depicts the object in accordance with the label. Alternatively, the request for the user input may request that the user input indicate an edge region of the object in accordance with the label.

In some implementations, process 400 may include identifying, with the machine learning model using the sensor data, and during the operating time period of the work machine at the worksite, an additional label for an additional object in the environment of the work machine, and storing additional sample data, from the sensor data, that relates to the additional object. Here, the presentation of the review information may sequentially present the sample data and the additional sample data.

As further shown in FIG. 4, process 400 may include receiving, via the user interface, the user input (block 440). For example, the controller 122 (e.g., using a memory, a processor, am input component, and/or a communication component) may receive, via the user interface, the user input, as described above. The user input may be for use as training data for the machine learning model. In some examples, the label for the object may indicate a terrain feature, and the user input may indicate a set of locations in the sample data that represent an edge region of the object.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The identification system described herein may be used with any machine that uses an object detection system. For example, the identification system may be used with the object detection system of a work machine that performs work tasks at a worksite, such as a compactor machine, a paving machine, a cold planer, a grading machine, a backhoe loader, a wheel loader, a harvester, an excavator, a motor grader, a skid steer loader, a tractor, a dozer, or the like. The object detection system may use a machine learning model to perform object detection for various objects of interest commonly present at a worksite, such as terrain features, infrastructure, and worksite accessories. In some cases, the object detection system may be prone to inaccurately detecting objects (e.g., due to insufficient training of the machine learning model). For example, the object detection system may fail to detect objects, falsely detect objects, and/or misidentify objects, thereby resulting in unnecessary avoidance actions being taken for the machine, excessive machine downtime, and/or work delays.

The identification system described herein is useful for generating accurate training data for a machine learning model. In particular, the identification system facilitates the real-time identification and tracking of potential object detection errors by the object detection system through the accumulation of sample data while the machine is operating at a worksite. Accumulating sample data enables assessment of object detection errors between periods of operation of the machine (e.g., during periods of inactivity), thereby reducing interruption to operation of the machine and reducing machine downtime. Furthermore, the identification system enables user-assisted review of potential object detection errors by a machine operator (e.g., the operator that was operating the machine when the error was made) or other personnel closely associated with a worksite, thereby improving error detection and correction. The resulting user-assisted data may be used for further training of the machine learning model, thereby improving the object detection capabilities of the machine learning model, particularly with respect to various objects of interest commonly present at a worksite, such as terrain features, infrastructure, and worksite accessories.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

As used herein, “a,” “an,” and a “set” are intended to include one or more items, and may be used interchangeably with “one or more. ” Further, as used herein, the article “the” is intended to include one or more items referenced in connection with the article “the” and may be used interchangeably with “the one or more. ” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An identification system, comprising:
a perception sensor configured to collect sensor data relating to objects in an environment of a work machine; and
a controller, communicatively coupled to the perception sensor, configured to:
identify, with a machine learning model using the sensor data, and during an operating time period of the work machine at a worksite, a label for an object in the environment of the work machine and a confidence value associated with the label;
store, based on the confidence value failing to meet a threshold, sample data, from the sensor data, that relates to the object; and
cause, after the operating time period, presentation of review information in a user interface of the work machine, wherein the review information includes the sample data and a request for user input relating to the label for the object.

2. The identification system of claim 1, wherein the request for the user input requests that the user input indicate whether the sample data depicts the object in accordance with the label.

3. The identification system of claim 1, wherein the review information further includes an indicia that distinguishes a region of the sample data, and
wherein the request for the user input requests that the user input indicate whether the region includes the object in accordance with the label.

4. The identification system of claim 1, wherein the request for the user input requests that the user input indicate a location in the sample data that depicts the object in accordance with the label.

5. The identification system of claim 1, wherein the request for the user input requests that the user input indicate an edge region of the object in accordance with the label.

6. The identification system of claim 1, wherein the object is a terrain feature.

7. The identification system of claim 1, wherein the object is a Jersey barrier, a portable toilet, a culvert section, or a wellhead.

8. The identification system of claim 1, wherein the operating time period concludes at a shut-down event for the work machine.

9. The identification system of claim 8, wherein the controller, to cause, after the operating time period, presentation of the review information in the user interface, is configured to:
cause presentation of the review information in the user interface at a start-up event for the work machine after the shut-down event.

10. The identification system of claim 1, wherein the controller, to store the sample data, is configured to:
store the sample data in association with metadata indicating the label and indicating a location in the sample data that represents the object.

11. A method, comprising:
identifying, with a machine learning model using sensor data collected by a perception sensor of a work machine, and during an operating time period of the work machine at a worksite, a label for an object in an environment of the work machine;
storing sample data, from the sensor data, that relates to the object;
causing, after the operating time period, presentation of review information in a user interface of the work machine, wherein the review information includes the sample data and a request for user input relating to the label for the object; and
receiving, via the user interface, the user input, wherein the user input is for use as training data for the machine learning model.

12. The method of claim 11, further comprising:
identifying, with the machine learning model using the sensor data, and during the operating time period of the work machine at the worksite, an additional label for an additional object in the environment of the work machine; and
store additional sample data, from the sensor data, that relates to the additional object.

13. The method of claim 12, wherein presentation of the review information sequentially presents the sample data and the additional sample data.

14. The method of claim 11, wherein the label for the object indicates a terrain feature, and
wherein the user input indicates a set of locations in the sample data that represent an edge region of the object.

15. The method of claim 11, wherein identifying the label for the object comprises:
identifying the label for the object and a confidence value associated with the label,
wherein the sample data is stored based on the confidence value failing to meet a threshold.

16. The method of claim 11, wherein the operating time period concludes at a shut-down event for the work machine, and
wherein causing, after the operating time period, presentation of the review information in the user interface comprises:
causing presentation of the review information in the user interface at a start-up event for the work machine after the shut-down event.

17. A work machine, comprising:
a perception sensor configured to collect sensor data relating to objects in an environment of the work machine; and
a controller, communicatively coupled to the perception sensor, configured to:
identify, with a machine learning model using the sensor data, and during an operating time period of the work machine at a worksite, a label for a terrain feature in the environment of the work machine;
store sample data, from the sensor data, that relates to the terrain feature; and
cause, after the operating time period, presentation of review information in a user interface, wherein the review information includes the sample data and a request for user input relating to the label for the object.

18. The work machine of claim 17, wherein the terrain feature is a pile, a berm, a ditch, or a trench.

19. The work machine of claim 17, wherein the perception sensor includes a camera, and the sensor data is image data collected by the camera.

20. The work machine of claim 17, wherein the operating time period concludes at a shut-down event for the work machine, and
wherein the controller, to cause, after the operating time period, presentation of the review information in the user interface, is configured to:
cause presentation of the review information in the user interface at a start-up event for the work machine after the shut-down event.
